(19) United States
(12) Patent Application Publication
(10) Pub. No.: US 2015/0311631 A1
(43) Pub. Date: Oct. 29, 2015

(54) HIGH-SPEED ELECTRICAL CONNECTOR

(71) Applicant: AMPHENOL SOCAPEX S.A, Thyez (FR)

(72) Inventors: Christophe BERNARDI, Sallanches (FR); Lionel POUJOL, Vougy (FR); Gabriel TUPIN, Vougy (FR)

(73) Assignee: AMPHENOL SOCAPEX S.A., Thyez (FR)

(21) Appl. No.: 14/421,788

(22) PCT Filed: Aug. 13, 2013
(86) PCT No.: PCT/FR2013/051935

§ 371 Date: Feb. 13, 2015

(30) Foreign Application Priority Data
Aug. 17, 2012 (FR) 1257852

(51) Int. Cl. H01R 13/631; H01R 24/44; H01R 13/6477

(52) U.S. Cl. CPC H01R 13/631; H01R 13/6477; H01R 24/44

(57) ABSTRACT

A high-speed electrical connector with constant characteristic impedance according to the invention has at least one pair of connection elements (15) installed in an insert (25) of insulating material, and the end portion of said insert is shaped so as to define a baffle (37) between the two connection elements (15).

The invention relates to a high-speed electrical connector, e.g. suitable for conveying “Ethernet” signals at a rate of about 10 gigabits per second. The invention relates more particularly to an improvement seeking to better conserve the characteristic impedance of a twisted pair of insulated electrical conductors.

A high-speed shielded connector is known that comprises at least one pair of connection elements of male or female type, said connection elements being parallel and installed in a cavity of oblong section having a metal wall forming shielding. The cavity houses an insert made of insulating material, of high dielectric constant, and forming a support for said connection elements.

When such a connector is a plug, it is for connecting to a data transmission cable having at least one pair of conductors that are twisted together. The conductors are surrounded by metal shielding. Two similar connectors may be connected to the ends of a cable having at least one such pair of conductors. The connector may also be in the form of an appliance inlet or outlet suitable for mounting on a support of an electronic appliance (e.g. on a wall of the housing of the appliance) in order to receive a plug-forming connector of the same type.

In this type of connector, it is common practice to have four pairs of connection elements connected to four conductor pairs. Each pair is surrounded by metal electromagnetic shielding. A line having such connectors thus has four high-speed data transmission channels. Overall outer shielding, both for the connector and for the cable, then protects the line(s) from external electromagnetic disturbances while the individual shielding on each of the twisted conductor pairs reduces crosstalk between the channels. U.S. Pat. No. 7,316,584 describes a connector of that kind.

In order to further increase the performance of such equipment, it is desirable to ensure that the characteristic impedance of the transmission line is well conserved, in particular at the intersection between two connectors that are connected together end-to-end. Good conservation of characteristic impedance all along the cabling serves to optimize the transmission of power between a transmitter and a receiver. In particular, the impedance of the receiver must be equal to the characteristic impedance of the line in order to avoid reflections. Local impedance mismatches can give rise to the appearance of standing wave phenomena that lead to transmission loses.

The invention enables this problem to be solved.

More particularly, the invention provides a high-speed connector comprising at least one pair of connection elements of male or female type that are parallel and installed in an insert of insulating material forming a support for said connection elements, each of said connection elements of said pair being electrically connected to an electrical conductor of a twisted pair, the connector being characterized in that the end portion of said insert is shaped to define a baffle between the two connection elements, which baffle is suitable for imparting dielectric contact to the abutment interface between said insert and another insert that is similar and forms part of another connector, thereby establishing dielectric continuity at said abutment interface.

In particular, the insert may be installed in a metal-walled cavity forming electromagnetic shielding. Said twisted pair may also be covered in a flexible metal sheath forming electromagnetic shielding. It is thus possible to provide continuity of the electromagnetic shielding around the pair of connection elements and beyond them.

In an element, the connector is characterized in that the end of said insert includes a tooth projecting along a direction parallel to a direction of said connection elements, and an adjacent notch that is parallel and that opens out at the root of said tooth, the tooth and the notch being substantially identical in shape and dimensions so as to co-operate respectively with a similar notch and a similar tooth of said other insert.

Impedance matching is thus conserved at the connection between the male and female connection elements belonging to the two connectors, since there is no longer any sudden break in the characteristics of the insulation at the interface. In particular, the sheet of air that remains in prior art devices between the ends of the two inserts is eliminated by the inserts contacting each other via the baffle.

In other words, the two inserts are in contact and interpenetrate over a certain length, thereby limiting variations of impedance in the connection zone.

The invention can be understood and other characteristics thereof appear more clearly in the light of the following description of an embodiment of a connector in accordance with the principle of the invention and given solely by way of example and with reference to the accompanying drawings, in which:

FIG. 1 is a fragmentary perspective view of the end of a connector in accordance with the invention;

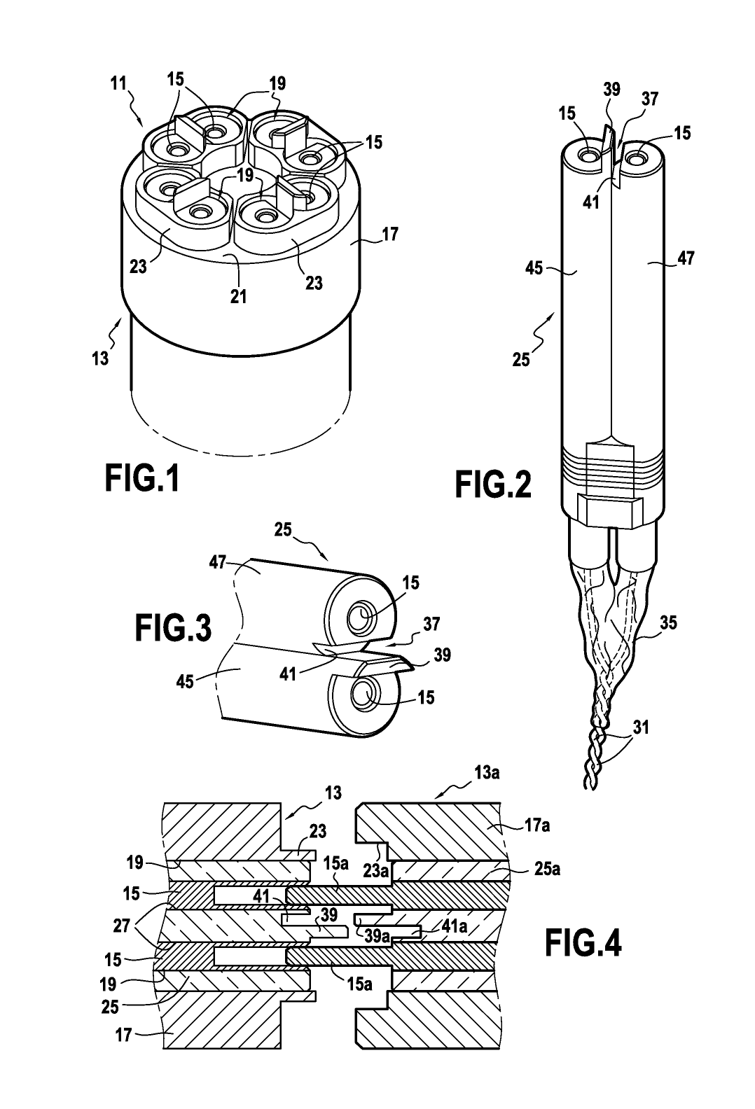

FIG. 2 is a detail view on a larger scale of an insert forming the support for two connection elements;

FIG. 3 is a view on a larger scale of the end of the insert; and

FIGS. 4 to 6 are fragmentary longitudinal section views showing how two inserts belonging to two similar complementary connectors co-operate, which connectors are respectively fitted with male and with female connection elements.

In FIG. 1, there can be seen the front face 11 of a high speed connector 13, specifically a portion of a socket-outlet, carrying female type connection elements. Other elements of the connector that are conventional are not shown, for example the elements that form part of external shielding surrounding the subassembly shown. FIG. 1 shows a body 17, which in this example has defined therein four longitudinally-extending cavities 19. In this example, each cavity is of oblong section and houses a pair of connection elements 15, the elements shown being of the female type. The walls of these cavities are at least metal-plated in order to provide electromagnetic shielding of the connection elements they contain. In the example, the body 17 as a whole is made of metal. The invention is applicable regardless of the number of cavities. In the example, the arrangement is conventional with four cavities 19 that are regularly spaced apart circumferentially in the body 17, which is generally cylindrical in shape. Beyond a base surface 21 of circular outline of the body 17, each cavity 19 is extended by a shielding skirt 23 suitable for coming into contact with a similar shielding skirt 23a of larger size belonging to another connector 13a (see FIG. 4) in order to provide continuity of electromagnetic shielding with that other connector, which other connector is provided with male type connection elements 15a in this example. The shielding skirt 23a slides outside the shielding skirt 23 of the connector 13 carrying the female type connection element 15.

Each cavity 19 houses an insert 25 made of insulating material. The characteristics of the insulating material are predetermined as a function of the characteristic impedance that is to be conserved. The insert 25 forms the support for two connection elements 15. In FIGS. 1 and 2, it can be seen that each female type connection element is housed in a duct 27 of the insert. The arrangement is similar for connection elements of male type. The two ducts are parallel, and consequently the two connection elements are parallel and spaced apart by a predetermined distance. Each connector element, of the female type in this example, has a tubular portion with an open end situated in the vicinity of an orifice of the corresponding duct 27 of the insert 25.

At the other end of the insert 25, two insulated conductors 31 are electrically connected respectively to the two connection elements 15. They are twisted together beyond the ducts 27 of the insert and the assembly of each twisted pair of conductors is covered in a flexible metal sheath 35 forming shielding for reducing crosstalk with other conductor pairs connected to the same connector.

In FIG. 4, there can be seen the same insert 25 fitted with two female type connection elements 15 and belonging to the same connector 13. Another insert 25a that is similar and that contains male type connection elements 15a in the form of pins can also be seen in FIG. 3. The pins engage in the female type connection elements 15. As shown, the other insert 25a is installed in another metal body 17a forming part of another connector 13a in accordance with the invention. The shielding skirt 23a of the cavity of this insert 25a is visible in FIG. 4, and its inside surface is in sliding contact with the outside surface of the corresponding shielding skirt 23 forming part of the connector 13.

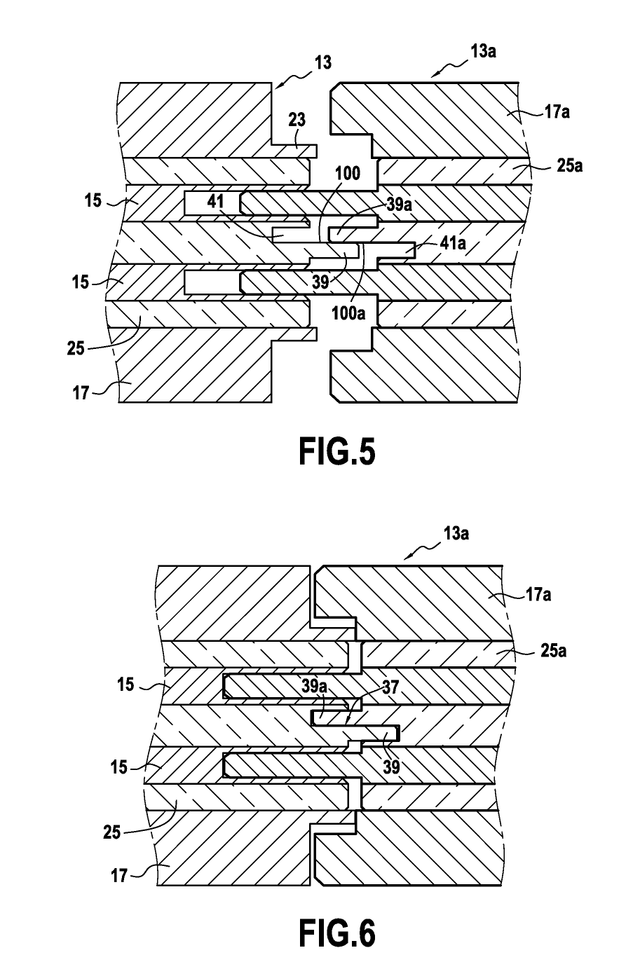

According to an important characteristic of the invention, the end portion of the insert 25 is shaped to define a baffle 37 providing dielectric contact at the abutment interface between said insert 25 and the other, similar insert 25a forming part of another connector 13a, as shown in FIGS. 5 and 6. The baffle 37 is situated between the two connection elements 15. Dielectric continuity is thus conserved at this abutment interface, in particular by the fact that the walls of the two inserts defining the baffle are in effective mechanical contact, preferably over at least the major portion of their surface areas.

In the example shown, the end of said insert includes a tooth 39 between the two connection elements, which tooth 39 projects in a direction parallel to that of the connection elements, and is adjacent to a notch 41 that is parallel and that opens out at the root of said tooth. The tooth 39 and the notch 41 are substantially identical in shape and dimensions so as to co-operate respectively with a notch 41a and a tooth 39a that are similar, forming parts of another insert 25a belonging to the other connector 13a and containing the pair of male type connection elements 15a, as can be seen in FIG. 4.

In FIG. 5, the connectors 13 and 13a are shown in a closer-together position during the operation of connecting the connectors 13 and 13a together. Thus, in this figure, it can be seen how a side surface 100 of the tooth 39 that projects into the notch 41 comes into contact with a corresponding side surface 100a of the tooth 39a. The inserts 25 and 25a are configured so that the surfaces 100 and 100a exert sideways pressure against each other, in particular in the final position shown in FIG. 6, in which these surfaces 100 and 100a form a central segment of the baffle 37 so as to ensure dielectric continuity between the inserts.

Since the teeth 39, 39a and the notches 41, 41a are of dimensions that are substantially equal, the assemblies formed by a tooth 39, 39a and a notch 41, 41a of each insert 25, 25a can be considered as being hermaphrodite. The hermaphrodite nature of these two-notched assemblies makes it possible to use substantially identical inserts 25, 25a for both connectors 13, 13a, thereby reducing production costs. Naturally, an insert containing female type connection elements needs to be brought into abutment with an insert containing male type connector elements, and vice versa. A connector in accordance with the invention can thus contain pairs of male connection elements or pairs of female connection elements. It is also possible for it to contain both pairs of male connection elements and pairs of female connection elements.

As can be seen more particularly in FIG. 2, said insert 25 has two substantially cylindrical segments 45 and 47 that are longitudinally side by side. The tooth 39 extends the side of one of the segments while the notch 41 extends into the side of the end portion of the other segment.

The insert 25 is made as a single piece.

As mentioned above, the connector may constitute a plug connected to a cord containing the various electrically insulated conductors. It may also constitute a socket suitable for being mounted on a support of any electronic appliance.

1. A high-speed connector comprising at least one pair of connection elements of male or female type that are parallel and installed in an insert (25) of insulating material forming a support for said connection elements, each of said connection elements of said pair being electrically connected to an electrical conductor of a twisted pair, wherein an end portion of said insert is shaped to define a baffle between the two connection elements, which baffle is suitable for imparting dielectric contact to the abutment interface between said insert and another insert that is similar and forms part of another connector, thereby establishing dielectric continuity at said abutment interface.

2. A connector according to claim 1, wherein the end of said insert includes a tooth projecting along a direction parallel to a direction of said connection elements, and an adjacent notch that is parallel and that opens out at the root of said tooth, the tooth and the notch being substantially identical in shape and dimensions so as to co-operate respectively with a similar notch and a similar tooth of said other insert.

3. A connector according to claim 2, wherein said insert comprises two substantially cylindrical segments that are side by side, in that the tooth is defined extending the side of one of the segments, and in that said notch extends into the end portion of the other segment along its side.

4. A connector according to claim 1, herein said insert is installed in a metal-walled cavity providing electromagnetic shielding.

5. A connector according to claim 1, wherein said twisted pair is covered in a flexible metal sheath forming electromagnetic shielding.

6. A connector according to claim 1, characterized in that it includes four pairs of connection elements.

7. A connector according to claim 6, wherein each of said pairs of connection elements is connected to a corresponding twisted pair.

8. A connector according to claim 1, forming a socket suitable for being mounted on a support of an electronic appliance.

9. A connector according to claim 1, forming a plug.
